(19) United States
(12) Patent Application Publication
(10) Pub. No.: US 2006/0239207 A1
(43) Pub. Date: Oct. 26, 2006

(54) Combined load balancing for overlay and ad hoc networks

(75) Inventor: Siamak Naghian, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/132,283

(22) Filed: May 19, 2005

(30) Foreign Application Priority Data
Apr. 20, 2005 (EP) 05008690.9

(51) Int. Cl. H04L 12/28; H04L 12/56

(52) U.S. Cl. 370/254; 370/400

(57) ABSTRACT

The present invention relates to a method and system for balancing load in a network environment comprising at least one ad hoc network and at least one overlay network, wherein at least one wireless mobile node of the ad hoc network is selected as a head node for collecting transmission related information, which is reported to a load balancing function of the network environment. There, the reported transmission related information is analyzed and a connection link within the network environment is selected.

### BACKGROUND OF THE INVENTION

1. Field of the Invention

The present invention relates to a system and methods of balancing load and link establishment in a network environment comprising at least one ad hoc network and at least one overlay network, such as a cellular or non-cellular wireless network.

2. Description of the Related Art

Traditional cellular systems have been very successful in providing voice services since the first analog system was introduced. In recent years, with the unprecedented increase in demand for personal mobility and dependence on personal communications, both the number of subscribers and the amount of wireless traffic have increased dramatically. Especially, wireless access to the Internet is expected to exacerbate the demand for bandwidth. The carriers and infrastructure providers now face a major challenge in meeting the increased bandwidth demand of mobile Internet users. At the same time; various efforts in providing different access services such as wireless LANs, ad hoc networks, Bluetooth and home RF (Radio Frequency) networks, are further stimulating the growth of wireless traffic and the requirement for a ubiquitous wireless infrastructure.

Ad hoc networks can be formed based on various networking paradigms: while some of them are formed independently others can benefit, to some extent, from the infrastructure assistance e.g. in terms of routing, security, etc. Depending on the way ad hoc networks are formed they can be called stand-alone or infrastructure and self-organized ad hoc networks and semi-infrastructure ad hoc networks e.g. combined cellular and ad hoc networks. Also, the term “mesh” is occasionally used to refer to the self-organized networks particularly when the nodes are stationary and the network is capable of handling higher bitrate and wider coverage e.g. for Wide Area Network and broadband access to the Internet. Mobile ad hoc networks consist of nodes, e.g. terminal devices, that move freely and communicate with other via wireless links. In a stand-alone mobile ad hoc network all nodes are alike and all are mobile. There are no base stations to coordinate the activities of subsets of nodes. Therefore, all the nodes have to collectively make decisions. All communication is over wireless links. A wireless link can be established between a pair of nodes only if they are within wireless range of each other. Beacon signals can be used to determine the presence of neighboring nodes. After the absence of some number of successive beacon signals from a neighboring node, it is concluded that the node is no longer a neighbor. Two nodes (source and destination nodes) that have a wireless link, henceforth, be said to be one wireless hop away from each other. They are also said to be immediate neighbors. Also, source and destination nodes can be a few hops from each other, referring to a multihop ad hoc network. Communication between nodes is over a single shared channel. The Multiple Access with Collision Avoidance (MACA) protocol may be used to allow asynchronous communication while avoiding collisions and retransmissions over a single wireless channel. MACA uses a Request To Send (RTS) and Clear To Send (CTS) handshaking to avoid collision between nodes. All nodes broadcast their node identity periodically to maintain neighborhood integrity.

In multi-hop ad hoc networks it is also necessary to find the best route from the source to the destination node. For this purpose, a wireless routing protocol and method e.g. Ad Hoc On-demand Distance Vector routing (AODV) is required. Currently, there are several wireless routing protocols that partly are being standardized in IETF under the Mobile Ad Hoc Networks (MANET) working group.

Continued proliferation of these different access services calls for interoperability between heterogeneous networks such as ad hoc and cellular systems or other types of overlay systems. In addition, such an interoperability will create heavier traffic in cellular systems as more and more traffic from wireless LANs, ad hoc networks and Bluetooth devices will be carried by the cellular infrastructure. For these reasons and the fact that the traffic in future cellular systems will be more bursty and unevenly distributed than conventional voice traffic, it is anticipated that congestion will occur in peak usage hours even in 3rd generation or 3G systems, which will have increased capacity. By congestion, it is meant that in some cells, data channels (DCHs) are less frequently available, thereby deteriorating the grade of service (GoS) in those cells to a level below a prescribed threshold (e.g. the GoS above 2%). It is noted, however, that control channels (CCHs) for signaling (or paging) may still be accessible by all mobile hosts (MHs) in a congested cell.

Presence of unbalanced traffic will exacerbate the problem of limited capacity in existing wireless systems. Specifically, some cells may be heavily congested (called hot spots), while other cells may still have enough available DCHs. In other words, even though the traffic load does not reach the maximum capacity of the entire system, a significant number of calls may be blocked and dropped due to localized congestion. Since the locations of hot spots vary from time to time (e.g., downtown areas on Monday morning, or amusement parks in Sunday afternoon), it is difficult, if not impossible, to provide sufficient resources in each cell in a cost-effective way. Congestion due to unbalanced traffic can be a real problem in wireless networks.

On the other hand, multi-mode devices equipped with cellular network modes and short-range radios e.g. WLAN, Bluetooth etc. are rapidly spreading around. Shortrange radios help the devices to form proximity communications. These devices can therefore form also local/proximity networks at the same time that they may have access to the infrastructure networks such as cellular (GSM, WCDMA, CDM2000, etc.). This coupled with the emerging services such as P2P (Peer-to-Peer) communications inherited from the Internet world bring new possibilities and challenges for the communication industry both in terms of systems and business model. There are P2P services available in the Internet that enable users to establish voice connections between two computers independent of any operator services. In a P2P communication mode, mobile nodes may establish a connection independent of the infrastructure. The P2P communication can be formed both over infrastructure or directly over the proximity ad hoc networks if such possibility exists. This situation raises many questions such as how the local P2P connections could be assisted by the infrastructure networks and mutually how the infrastructure networks can benefit from the local communications that can partly happened in P2P mode.

Recently, a novel approach has been proposed, which shows a direction of how to evolve from the existing, heavily-invested cellular infrastructure to next generation-wireless systems that scale well with the number of mobile hosts and, in particular, overcome the congestion by dynamically balancing the load among different cells in a cost-effective way. The scheme combines conventional cellular technology and ad hoc wireless networking technology. The basic idea of the proposed system, called iCAR (integrated Cellular and Ad hoc Relay), is to place a number of ad hoc relay stations (ARSs), basically fixed light base stations with relay functionality, at strategic locations, which can be used to relay signals between MHs and base stations. By using these ARSs, it is possible to divert traffic from one (possibly congested) cell to another (non-congested) cell. This helps to circumvent congestion, and makes it possible to maintain (or hand-off) calls involving MHs that are moving into a congested cell, or to accept new call requests involving MHs that are in a congested cell.

However, the above iCAR system relies on costly modifications of the network infrastructure and architecture by seeding fixed relay stations (i.e. ARSs) which become part of the infrastructure. This way, they help extend the radio access network and its coverage and help the network connectivity by benefiting from the stationary relay stations that supposed to be cheaper than the conventional base stations.

### SUMMARY OF THE INVENTION

It is therefore an object of the present invention to provide an improved load balancing method and system which does not require any modifications to the network infrastructure and architecture.

This object is achieved by a method of balancing load and link establishment in a network environment comprising at least one ad hoc network and at least one overlay network, said method comprising the steps of:
selecting at least one wireless mobile node of said ad hoc network as a head node for collecting transmission related information;
reporting said collected transmission related information to a load balancing function of said network environment;
analyzing said reported transmission related information; and
selecting a connection link within said network environment based on the result of said analyzing step.

Furthermore, the above object is achieved by a mobile node of an ad hoc network, comprising:
collecting means for collecting transmission related information received from other mobile nodes of said ad hoc network; and
reporting means for reporting said collected transmission related information to a load balancing function of a network environment which comprises said ad hoc network.

Additionally, the above object is achieved by a network device for balancing load in a network environment comprising at least one ad hoc network and at least one overlay network, said network device comprising:
receiving means for receiving transmission related information reported from at least one mobile node of said ad hoc network;
analyzing means for analyzing said reported transmission related information;

and
load balancing means for selecting a connection link within said network environment in response to said analyzing means.

Further, the above object is achieved by a method of obtaining transmission related information from an ad hoc network, said method comprising the steps of:
collecting transmission related information received from other mobile nodes of said ad hoc network; and
reporting said collected transmission related information to a load balancing function of a network environment which comprises said ad hoc network.

In addition, the above object is achieved by a method of controlling data routing in a network environment comprising at least one ad hoc network and at least one overlay network, said method comprising the steps of:
receiving transmission related information reported from at least one mobile node of said ad hoc network;
analyzing said reported transmission related information; and
selecting a connection link within said network environment in response to said analyzing step.

The above method steps of solving the above problem may be implement as concrete hardware circuits or based on software routines comprising code means for producing the above method steps when run on a computer device which may comprise or be part of the respective mobile or network nodes.

Accordingly, the proposed load balancing scheme relies on local ad hoc (single and multihop) networks formed by mobile nodes, i.e. basically end-users terminals, so that modifications to the network infrastructure and architecture are not necessary. Rather, benefits are obtained from existing mobile terminals and wireless peer-to-peer applications are realized that could be assisted by control signaling on the overlay network.

Efficient use of both radio and physical resources of both mobile devices and network is promoted. Moreover, the proposed solution benefits from local networking mainly realized by short-range radios such as WLAN (Wireless Local Area Network), Bathetic etc., which brings about new business opportunities for network operators and service providers to share the capacity and balance aggregated load. Both network and terminal vendors will also benefit from this development. This approach paves the way of Always Best Connected (ABC) scenario in service providing, including bearer services and applications, and provides good future opportunities for multimode terminals (WLAN, Bluetooth, GSM (Global System for Mobile communications), etc.) and network's lead services extension.

The at least one overlay network may comprises a cellular network, such as GSM or WCDMA (Wideband Code Division Multiple Access), or a non-cellular wireless network, such as WLAN or the like. The at least one ad hoc network may comprises a local ad hoc network and a proximity ad hoc network.

Furthermore, the transmission related information may be collected from at least one of mobile nodes of the ad hoc network, access points between the ad hoc network and the overlay network, and a radio access control level of the overlay network. The transmission related information may be any information specifying parameters suitable for balancing the load of a network in which or through which the transmission occurs. As an example, the transmission related information may comprise at least one of a load information and a network topology related information. The selection of the connection link may comprise selection of an optimal access point for communication with the network environment.

In general, the analyzing step may be adapted to take into consideration the overall load, Quality of Service (QoS), cost-efficiency or other metrics in the network environment. The load balancing function may be provided in the overlay network. Moreover, the load balancing function may be adapted to divide traffic of the selected connection link into user paths and control paths, and to route user data through a user path in the ad hoc network and control data through a control path in the overlay network e.g. in case of local P2P communications, where a direct connection of a P2P communication is used as the selected connection link. Then, the control path can be terminated in the overlay network. The direct connection may be established under assistance of the overlay network.

Quasi-connection control may be allocated to the overlay network over the at least one ad hoc network at the time of load sharing. Thus, local load sharing over proximity and ad hoc networks while handling a quasi connection control in the centralized overlay network can promote both physical and radio resource utilization of the cellular network in the future.

Additionally, the at least one selected head node may be used for collecting topology data.

A correct one out of the selected at least one head node may be determined and traffic of the selected connection may be routed via the determined correct head node.

Furthermore, the load balancing function may be adapted to use hierarchical load sharing. As a specific example, the hierarchical load sharing may comprise low level load balancing executed at ad hoc and proximity network level, medium level load balancing executed at boarders between said at least one ad hoc networks and the at least one overlay networks, and high level load balancing executed at radio access control level.

Further advantageous modifications are defined in the dependent claims.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 shows a schematic network and signaling diagram indicating a load balancing architecture according to the preferred embodiment;

FIG. 2 shows a schematic block diagram of a network device according to the preferred embodiment; and

FIG. 3 shows a schematic block diagram of a mobile node according to the preferred embodiment.

### DETAILED DESCRIPTION OF THE PREFERRED EMBODIMENTS

In the following, the preferred embodiments will be described in connection with a load balancing procedure in a combined multi-access and ad hoc network environment comprising at least one ad hoc network and at least one overlay network, for example a cellular wireless network.

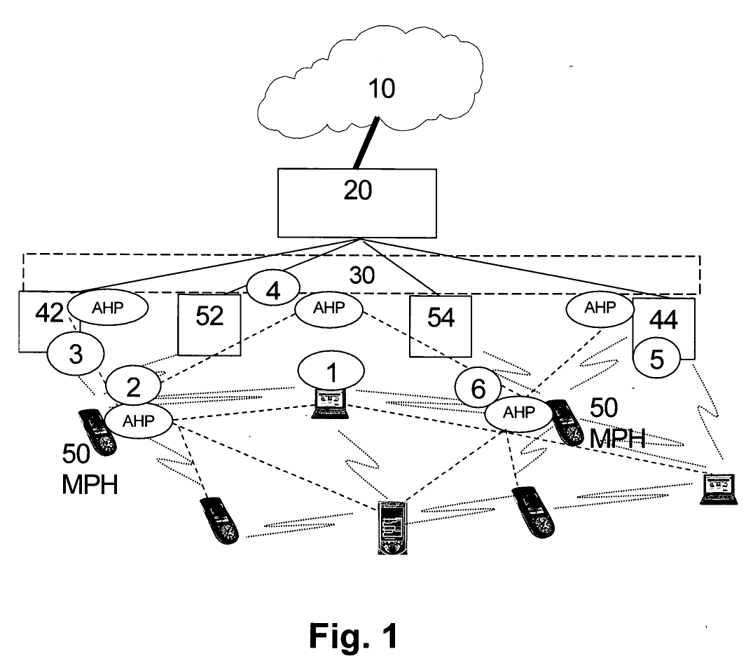

FIG. 1 shows a schematic network and signaling diagram indicating a load balancing architecture according to the preferred embodiment. An IP (Internet Protocol) backbone or cellular network 10 can be accessed via a multi-access control functionality 20 and a load balancing functionality or load balancer 30. The access can be achieved by access points 42, 44 which are radio-connected to mobile nodes indicated in FIG. 1 as different types of wireless terminals, e.g. mobile phones, laptops, palmtops and the like, which are configured to build the at least one ad hoc network. Furthermore, the mobile nodes may be connected to base station devices 52, 54, e.g. base transceiver stations (BTS), of the overlay network.

According to the preferred embodiment, the proposed load balancing method implemented by the load balancer 30 may be configured to use hierarchical load sharing, wherein a lowest or low level load balancing is executed at ad hoc and proximity network level. Furthermore, middle hierarchy or medium level load balancing is executed at the boarder of ad hoc and/or proximity sub-networks and the base station devices 52, 54 of the overlay network. The highest load sharing hierarchy or high level load balancing is executed at radio access control level and in case of multi access it can be executed at the common radio access control.

The information for the load balancing is extracted from the lower level and reported by the mobile devices. Also, base station resources can be used when the load balance is executed at the higher hierarchy levels. Pulses or radio resource procedures can be used for collecting load balance information. In case of pulse information a certain number of the mobile nodes or base station devices act as a head node, e.g. pulse master or multi-path head (MPH) 50, for handling the related load information. The load balancing information is collected at the multi-path heads (MPH), which can be implemented as a logical entity, e.g. ad hoc pulse (AHP), that can be in a specific number of mobile nodes or in a certain number of base station devices or other elements of the radio access network.

Thereby, a combined load balancing method and procedures are proposed to share the overlay network load by benefiting from the local and proximity ad hoc networks that are envisaged to form the future ubiquitous networks. The overlay network(s) could provide a kind of quasi-connection control over the local and proximity ad hoc networks at the time of load sharing to handle for example charging, security, and QoS control over the proximity and ad hoc networks. For example, in a P2P case while mobile devices have direct connections established assisted by the overlay network, the user data can be conveyed directly over local network while the control data can be also terminated in the overlay network. This could help the service providers and operators to develop secured and assisted P2P communications (connection establishment, maintenance, switching from local to global connections and vice versa, charging, etc.) over proximity networks. The local ad hoc network may utilize a pulse flooding type of procedure to help reduce the power consumption of the mobile device.

In the following, a simple use case of the proposed load balancing procedure is described with reference to the encircled numbers shown in FIG. 1 and allocated to specific network entities.

Initially, mobile node “1” in the ad hoc sub-network has a connection to the overlay network via mobile node “2” and AP 42 designated “3”. Based on the information collected in the MPH entities 50 and analyzed in the load balancer 30 it is concluded that the original connection link via AP “3” and mobile node “2” is fully occupied. Also, based on the collected load information it is seen that mobile node “1” has a route to AP 44 designated “5” via mobile node “6” and the route is free to be used. Also, it is determined that the AP “5” is under loaded. Hence, the load balancer indicates to the AP “5” to take the connection in. This step may include also the basic information from mobile node “1” and the security association. In response thereto, the AP “5” send an acknowledgement to the load balancer 30 and, if the request has been accepted, the load balancer 30 informs the mobile node “1” to take an action to setup the new connection via mobile node “6” to the AP “5”. Then, upon setting up the new connection, the mobile node “1” informs the load balancer 30 and the load balancer 30 releases the original connection and corresponding resources.

Next, an ad hoc transfer use-case is described using the encircled numbers shown in FIG. 1 and allocated to the specific network entities.

Initially, mobile node “2” has a connection to mobile node “6” via the overlay network, i.e. via AP “3” and AP “5”. These mobile nodes “2” and “6” inform their proximity ad hoc capability to the load balancer 30 which triggers the network-based routing up that a single or multihop ad hoc path between the nodes is established. Alternatively, the routing can be executed independently by using ad hoc routing. The network may also provide the security associations for mobile node “2” and mobile node “6” to form a secure path. When an ad hoc secure path has been established between the nodes, the load balancer 30 informs the nodes to make the connection local. This means that for example only user data is transferred via the ad hoc path but control signaling kept alive with the overlay network. This may be needed e.g. for security and charging purposes. The mobile nodes “2” and “6” report the beginning and ending of the ad hoc connection to the overlay network. The load balancer 30 may swap the ad hoc connection to the pure network connection and vice versa on a need basis.

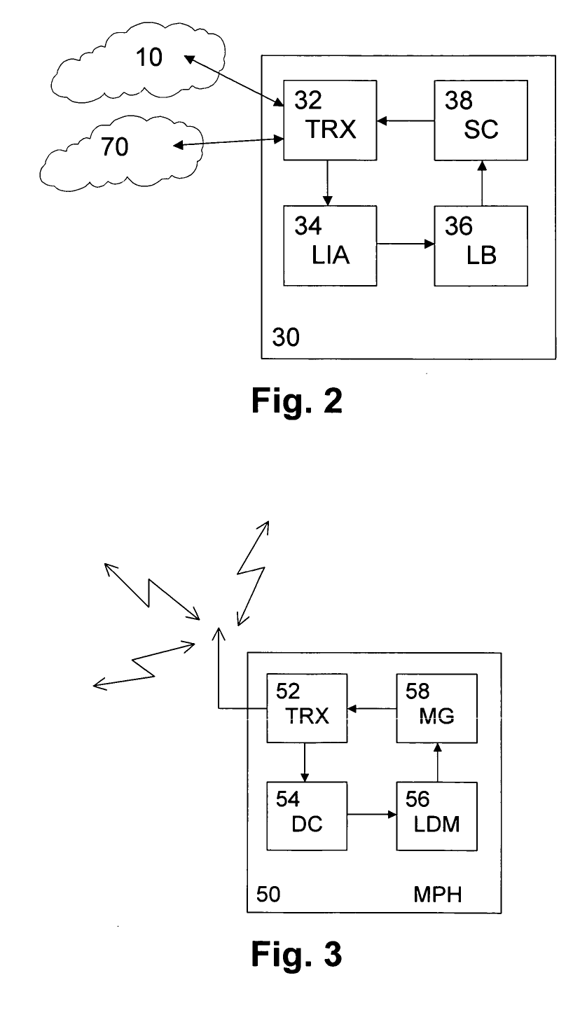

FIG. 2 shows a schematic block diagram of a network device, e.g. a radio network controller (RNC) or the like, which is reduced to the functionalities required for implementing the load balancer 30.

The load balancer 30 comprises a transceiver 32 for transmitting and receiving messages to/from the at least one overlay network 10 and the at least one ad hoc network 70. a load information analyzing unit 34 extracts and analyzes reported collections of load information and optional topology information received from the selected head nodes, e.g. MHPs 50, of the overlay network 10 and ad hoc network 70. The output of the analyzing unit 34 which may indicate the load situation in the network environment is supplied to a load balancing unit 36 which selects based on the load situation and network topology at least one of an access point and a connection link within the whole network environment comprising the at least one ad hoc network 70 and overlay network 10 for each of specific connections to balance the overall network load. A load control information indicating the selected access point and/or connection link is then supplied to signaling control unit 38 which generates a corresponding control signaling so as to effect the load control measures, i.e. changes in connection links and/or access points, decided by the load balancing unit 36.

FIG. 3 shows a schematic block diagram of a mobile node, e.g. a wireless terminal device or the like, which is reduced to the functionalities required for implementing the load reporting functionality of the head node, e.g., MPH 50.

The mobile node 50 comprises a wireless transceiver 52 for transmitting and receiving messages to/from base stations and/or APs of the at least one overlay network 10 and other mobile nodes of the at least one ad hoc network 70. A load data collection unit 54 extracts and collects load data and optional topology data received e.g. in respective messages from the other mobile nodes of the ad hoc network 70. The collected load and optional topology data may be stored in a load data memory or memory portion 56. at regular or predetermined timings, a message generation unit 58 reads the collected load and optional topology data from the load data memory 56 and generates a load reporting message to be transmitted by the transceiver 52 to the load balancer 30.

In summary, a method and system for balancing load and link establishment in a network environment comprising at least one ad hoc network and at least one overlay network has been described, wherein at least one wireless mobile node of the ad hoc network is selected as a head node for collecting load information, which is reported to a load balancing function of the network environment. There, the reported load information is analyzed and a connection link within the network environment is selected.

It is noted that the functions or units shown in FIGS. 2 and 3 may be implemented as software routines which are configured to run a computer device or processor device provided in the mobile node 50 or load balancer 30. As an alternative, the units or function as indicated by the blocks of FIG. 2 and 3 may be implemented as discrete hardware circuits.

Furthermore, it is to be noted that the present invention is not restricted to the above preferred embodiment and can be implemented in any multi-access network environment with ad hoc network(s) and overlay networks. The load balancer 30 may be implemented as a central device or as a number of distributed devices which may be responsible for certain network areas. The preferred embodiments may thus vary within the scope of the attached claims.

What is claimed:

1. A method of balancing load and link establishment in a network environment comprising at least one ad hoc network and at least one overlay network, said method comprising the steps of:
a) selecting at least one wireless mobile node of said ad hoc network as a head node for collecting transmission related information;
b) reporting said collected transmission related information to a load balancing function of said network environment;
c) analyzing said reported transmission related information and outputting a result indicative thereof; and
d) selecting a connection link within said network environment based on the result of said analyzing step.

2. A method according to claim 1, wherein said at least one overlay network comprises a cellular wireless network.

3. A method according to claim 1, wherein said at least one overlay network comprises a non-cellular wireless network.

4. A method according to claim 1, wherein said at least one ad hoc network comprises a local ad hoc network and a proximity ad hoc network.

5. A method according to claim 1, wherein said mobile node comprises a wireless terminal device.

6. A method according to claim 1, wherein said transmission related information is collected from at least one of mobile nodes of said ad hoc network, access points between said ad hoc network and said overlay network, and a radio access control level of said overlay network.

7. A method according to claim 1, wherein said selection step comprises selecting an optimal access point for communication with said network environment.

8. A method according to claim 1, wherein said analyzing step comprises considering at least one of an overall load, Quality of Service (QoS), and cost-efficiency in said network environment.

9. A method according to claim 1, further comprising the step of:
dividing, using said load balancing function, traffic of said selected connection link into user paths and control paths; and
routing user data through a user path of said user paths in said ad hoc network and control data through a control path of said control paths in said overlay network.

10. A method according to claim 9, further comprising the step of:
using a direct connection of a peer-to-peer communication as said selected connection link.

11. A method according to claim 10, further comprising the step of:
terminating said control path in said overlay network.

12. A method according to claim 10, further comprising the step of:
establishing said direct connection under assistance of said overlay network.

13. A method according to claim 1, further comprising the step of:
using said head node for collecting topology data.

14. A method according to claim 1, wherein said load balancing function is provided in said overlay network.

15. A method according to claim 1, further comprising the steps of:
determining a correct head node from said selected at least one head node; and
routing traffic of said selected connection link via said determined correct head node.

16. A method according to claim 1, further comprising the step of:
allocating to said overlay network quasi-connection control over said at least one ad hoc network at a time of load sharing.

17. A method according to claim 1, wherein said load balancing function is adapted to use hierarchical load sharing.

18. A method according to claim 17, wherein said hierarchical load sharing comprises a low level load balancing executed at ad hoc and at a proximity network level, a medium level load balancing executed at boarders between said at least one ad hoc networks and said at least one overlay networks, and a high level load balancing executed at a radio access control level.

19. A method according to claim 1, wherein said transmission related information comprises at least one of a load information and a network topology related information.

20. A mobile node of an ad hoc network, comprising:
a) means for collecting transmission related information received from other mobile nodes of said ad hoc network; and
b) means for reporting said collected transmission related information to a load balancing function of a network environment, which comprises said ad hoc network.

21. A mobile node according to claim 20, wherein said mobile node comprises a wireless terminal device.

22. A mobile node according to claim 20, wherein collecting means are configured to collect said transmission related information from at least one of mobile nodes of said ad hoc network, access points between said ad hoc network and said overlay network, and a radio access control level of said overlay network.

23. A mobile node according to claim 20, wherein said collecting means are configured to collect topology data.

24. A mobile node according to claim 20, wherein said transmission related information comprises at least one of load information and network topology related information.

25. A network device for balancing load in a network environment comprising at least one ad hoc network and at least one overlay network, said network device comprising:
a) receiving means for receiving transmission related information reported from at least one mobile node of said ad hoc network;
b) analyzing means for analyzing said reported transmission related information; and
c) load balancing means for selecting a connection link within said network environment in response to said analyzing means.

26. A network device according to claim 25, wherein said load balancing means are configured to select an optimal access point for communication with said network environment.

27. A network device according to claim 25, wherein said load balancing means (36) are configured to take into consideration an overall load in said network environment.

28. A network device according to claim 25, wherein said load balancing means are configured to divide traffic of said selected connection link into user paths and control paths, and to route user data through a user path of said user paths in said ad hoc network and control data of said control paths through a control path in said overlay network.

29. A network device according to claim 25, wherein said load balancing means are configured to determine a correct one out of said selected at least one head node, and to route traffic of said selected connection via said determined correct head node.

30. A network device according to claim 25, wherein said load balancing means are configured to allocate to said overlay network quasi-connection control over said at least one ad hoc network at a time of load sharing.

31. A network device according to any one of claims 25, wherein said load balancing means are configured to use hierarchical load sharing.

32. A network device according to claim 31, wherein said hierarchical load sharing comprises a low level load balancing executed at ad hoc and at a proximity network level, a medium level load balancing executed at boarders between said at least one ad hoc networks and said at least one overlay networks, and a high level load balancing executed at radio access control level.

33. A network device according to any one of claims 25, wherein said network device comprises a radio network controller.

34. A network device according to any one of claims 25, wherein said transmission related information comprises at least one of load information and network topology related information.

35. A method of obtaining transmission related information from an ad hoc network, said method comprising the steps of:
a) collecting transmission related information received from other mobile nodes of said ad hoc network; and
b) reporting said collected transmission related information to a load balancing function of a network environment, which comprises said ad hoc network.

36. A method of controlling data routing in a network environment comprising at least one ad hoc network and at least one overlay network, said method comprising the steps of:
a) receiving transmission related information reported from at least one mobile node of said ad hoc network;
b) analyzing said reported transmission related information; and
c) selecting a connection link within said network environment in response to said analyzing step.

37. A computer program embodied within a computer readable medium, the computer program obtaining transmission related information from an ad hoc network and being configured to perform the steps of:
a) collecting transmission related information received from other mobile nodes of said ad hoc network; and
b) reporting said collected transmission related information to a load balancing function of a network environment, which comprises said ad hoc network.

38. A computer program embodied within a computer readable medium, the computer program controlling data routing in a network environment comprising at least one ad hoc network and at least one overlay network and being configured to perform the steps of:
a) receiving transmission related information reported from at least one mobile node of said ad hoc network;
b) analyzing said reported transmission related information; and
c) selecting a connection link within said network environment in response to said analyzing step.

39. A system for balancing load in a network environment comprising at least one ad hoc network and at least one overlay network, said system comprising:
at least one mobile node of said at least one ad hoc network, comprising
a) means for collecting transmission related information received from other mobile nodes of said at least one ad hoc network,
b) means for reporting said collected transmission related information to a load balancing function of said network environment, which comprises said at least one ad hoc network; and
a network device, comprising
a) receiving means for receiving said transmission related information reported from at least one mobile node of said at least one ad hoc network,
b) analyzing means for analyzing said reported transmission related information, and
c) load balancing means for selecting a connection link within said network environment in response to said analyzing means.
